(19) United States
(12) Patent Application Publication
(10) Pub. No.: US 2021/0226483 A1
(43) Pub. Date: Jul. 22, 2021

(54) ELECTRIC MOTOR

(71) Applicant: INTELLITECH PTY LTD, Malvern (AU)

(72) Inventors: Victor SHLAKHETSKI, Ashkelon (IL); Alexander MOSTOVOY, Ashkelon (IL)

(73) Assignee: INTELLITECH PTY LTD, Malvern (AU)

(21) Appl. No.: 17/224,589

(22) Filed: Apr. 7, 2021

Related U.S. Application Data
(63) Continuation of application No. 16/090,305, filed on Oct. 1, 2018, now abandoned.

(30) Foreign Application Priority Data
Apr. 4, 2016 (GB) 1605744.0

(51) Int. Cl. H02K 1/14; H02K 11/215; H02K 1/27; H02K 3/04; H02K 21/14; H02K 29/08

(52) U.S. Cl. CPC H02K 1/141; H02K 11/215; H02K 1/2753; H02K 29/08; H02K 3/04; H02K 21/14; H02K 1/2793

(57) ABSTRACT

An electric motor which comprises: (A) a rotor which comprises: (a.1) a co-centric shaft and disk; and (a.2) a plurality of permanent magnets that are equi-angularly spaced and equi-radially disposed on said disk in a ring-like structure! and, (B) a stator which comprises: (b.1) a plurality of coils having a U-shaped structure in top view and double C-shaped structure in side view, said coils are equi-angularly spaced and equi-radially disposed with respect to said disk of the rotor, each section of said C-shaped structure has a cavity through which said ring-like structure and disk rotationally move; and (b.2) a plurality-of-windings coil within each of said U-shaped coils.

### FIELD OF INVENTION

The invention relates to the field of electric motors. More specifically, the invention relates to an electric motor which includes coils that are placed at the stator, and permanent magnets that are placed on a disk-type rotor.

### BACKGROUND OF THE INVENTION

Electric motors of the rotational type are well known, and have been widely used for many years now for converting electrical energy to mechanical energy. A typical electric motor comprises a rotor and a stator.

The rotor is the moving part of the motor, and it comprises the turning shaft which delivers the rotation to the load. The rotor usually has conductors laid into it, which carry currents that interact with the magnetic field of the stator to generate the forces that turn the shaft. In another alternative, the rotor comprises permanent magnets, while the stator holds the conductors.

The stator, in turn, is the stationary part of the motor's electromagnetic circuit, and it usually has either windings or permanent magnets. The stator bobbin is typically made up of many thin metal sheets, called laminations. Laminations are used to reduce energy losses that would result if a solid bobbin were used.

Electric motors are also used in a reversed functionality to convert mechanical energy to electric energy, and in such a case, the electric motor is in fact an electric generator.

However, while the electrical motor operates to convert electrical energy to mechanical energy, a parasitic magnetic flux is produced within the electrical motor, resulting in the generation of electric energy called CEMF (Counter Electro-Motive Force), in addition to the production of the desired mechanical energy. This parasitic electric energy in fact reduces the total mechanical energy which is obtained from the motor. The parasitic electric energy that is produced within the motor may reach up to 80% of the total energy at 3000 Rpm and 20% at 1000 Rpm. All attempts to eliminate this amount of parasitic energy, which is inherent to the structure of the typical electric motor, have reached some limit, but they could not eliminate this parasitic energy altogether.

U.S. Pat. No. 8,643,227, by Takeuchi discloses a linear motor which uses a permanent magnet that moves within a coil.

It is an object of the present invention to provide a new structure of an electric motor in which the parasitic energy in the form of electric voltage generation, which is caused in prior art motors due to a reversed magnetic flux, is substantially eliminated.

It is still another object of the invention to provide an electric motor which can operate at a very high rotational speed.

It is still another object of the invention to provide a safer electrical motor, which requires supply of low current to each of the coils.

It is still another object of the invention to provide an electrical motor having a simple and inexpensive structure.

It is still another object of the invention to provide an electrical motor having an increased efficiency compared to prior art motors.

Other objects and advantages of the invention will become apparent as the description proceeds.

Other objects and advantages of the invention will become apparent as the description proceeds.

### SUMMARY OF THE INVENTION

An electric motor which comprises\hat{ } (A) a rotor which comprises\hat{ } (a.1) a co-centric shaft and disk; and (a.2) a plurality of permanent magnets that are equi-angularly spaced and equi-radially disposed on said disk in a ring-like structure! and, (B) a stator which comprises\hat{ } (b.1) a plurality of coils having a U-shaped structure in top view and double C-shaped structure in side view, said coils are equi-angularly spaced and equi-radially disposed with respect to said disk of the rotor, each section of said C-shaped structure has a cavity through which said ring-like structure and disk rotationally move! and (b.2) a plurality-of-windings coil within each of said U-shaped coils.

In an embodiment of the invention, the U-shaped coils are attached to a stator base.

In an embodiment of the invention, a ferromagnetic core is disposed between any two adjacent permanent magnets of the rotor, thereby to form a close ring.

In an embodiment of the invention, a DC current whose direction is alternated is supplied to said coils of the coils.

In an embodiment of the invention, all said coils are connected in parallel, such that they are all fed from a single DC source.

In an embodiment of the invention, the electric motor further comprises one or more sensors for sensing the position of the one or more of said permanent magnets relative to said coils, respectively, and for providing indication as to when to alter the direction of the DC current, respectively.

In an embodiment of the invention, each of said sensors is a Hall-type sensor.

In an embodiment of the invention, said alterations of the direction of the DC current is caused by a controller, and wherein said alterations are timed by a signal which is received from said one or more sensors.

In an embodiment of the invention, the poles of adjacent permanent magnets are arranged such that identical poles face one another, in an S-S, N-N . . . arrangement.

In an embodiment of the invention, the windings in each of the plurality of coils are formed by a single conductor which is repeatedly wound around a coil bobbin.

In an embodiment of the invention, the electric motor is of relatively low current and relatively high voltage.

In an embodiment of the invention, the number of said permanent magnets is twice the number of said U-shaped coils.

### BRIEF DESCRIPTION OF THE DRAWINGS

In the drawings:

FIG. 1 shows a general structure of the motor according to an embodiment of the present invention!

FIG. 2 shows another view of the motor, according to an embodiment of the invention!

FIG. 3 illustrates how the coils are wound around each of the bobbins of the coils of the motor of the present invention.

### DETAILED DESCRIPTION OF PREFERRED EMBODIMENTS

As noted above, the typical electrical motors of the prior art suffer from a significant parasitic magnetic flux, which results in the generation of a reversed electrical energy (CEMF), in addition to the mechanical (rotational) energy that the motor is intended to produce. Such generation of parasitic electrical energy results in a significant loss of energy.

The motor of the present invention very significantly reduces such losses of energy, while using a relatively low current and a relatively high voltage supply.

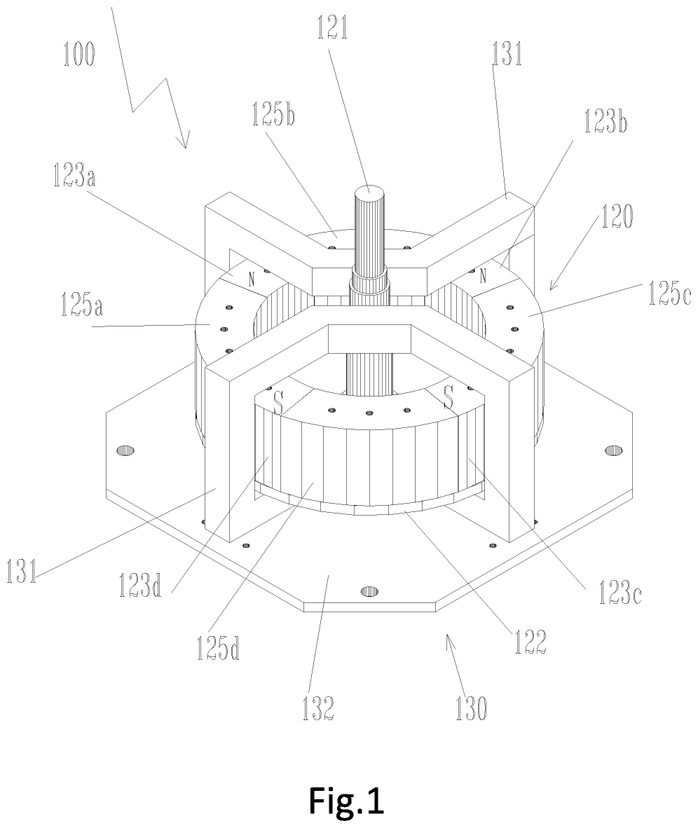

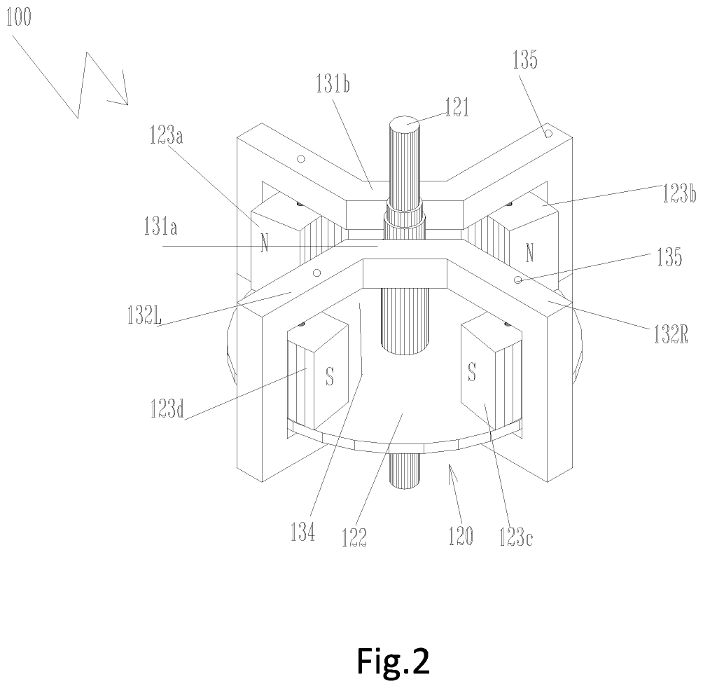

FIG. 1 shows the basic structure of an electrical motor 100 according to an embodiment of the present invention. The electric motor 100 comprises mainly a rotor 120 and a stator 130. The stator 130 in turn comprises a plurality of coils 131a, 131b, 131c, . . . 131n, each being wound over a respective bobbin (the exemplary embodiment of FIG. 1 comprises two of such coils), that are equi-angularly spaced and equi-radially fixed to a stator base 132. The term “equi-radially” (which is used herein for the sake of brevity), assumes a circular stator base 130, however, the stator base 130 may have any shape, and in that case all the coils are placed at a same distance from a central point of the base. Each of the coils 131 comprises of substantially two C-shaped structures in a side-view cross section (left C-shaped structure 132L, and right C-shaped structure 132R—see FIG. 2), that are connected together at their top and bottom, respectively, by a connecting section 132c, to form a substantially U-shaped structure in top view cross-section (for the sake of brevity the coils 131 will be referred herein as U-shaped coils). The opening in each of the C-shaped structures forms a cavity 134 for permanent magnets 123 that are in turn arranged in a ring-like structure over a disk base 122 of the rotor, which is in turn attached at its center to shaft 121. As will be elaborated hereinafter, the U-shaped coils are in fact hollowed, to contain plurality, typically many (for example, several tens or more) coil windings.

More specifically, the rotor 120 comprises a shaft 121, disk 122, and a plurality of permanent magnets 123 (123a-123b in this specific embodiment) that are placed on it. As shown, the plurality of permanent magnets 123 have a cross sectional shape, which is adapted to pass through the cavity 134 of each of the C-shaped structures. The permanent magnets 123 are equi-angularly spaced and equi-radially placed on disk 122 in a ring-like manner, to pass through each of said cavities 134. The permanent magnets 123 are placed on rotor disk 122 such that identical poles of any two adjacent magnets face one another, respectively (i.e., in an S pole facing S pole, N pole facing N pole, etc.). In one embodiment, and as shown in the exemplary embodiment of FIG. 1, a ferromagnetic (e.g., iron) core 125 is disposed between any two adjacent magnets 123. Therefore, the set of all the permanent magnets 123, together with the set of all the ferromagnetic cores 125 (when exist) in between adjacent magnets, form a circular ring-like structure which passes through all the cavities 134 of the set of coils 131, respectively, allowing free rotation of the rotor disk 122, while the ring-like arrangement is continuously maintained within said cavities of the coils 131.

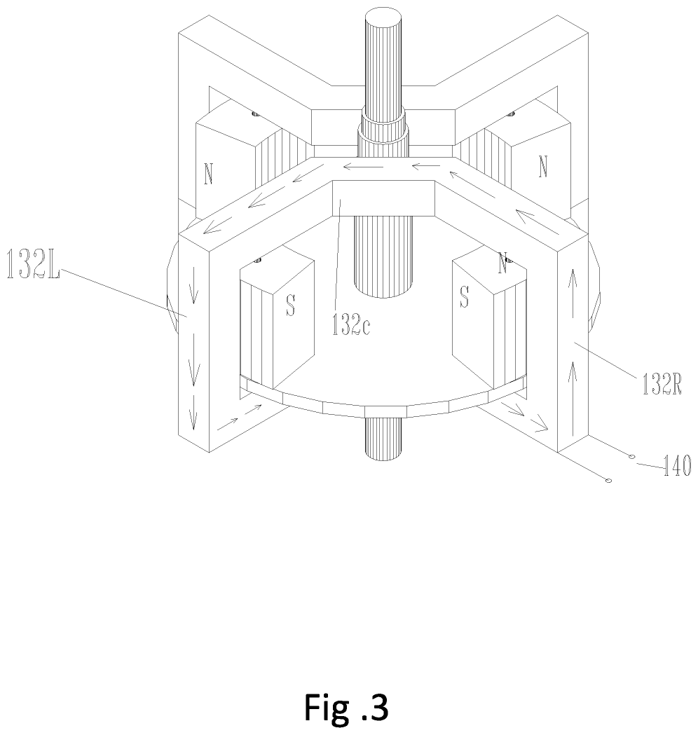

FIGS. 1-3 show an embodiment with two U-shaped coils, however, more coils may be used. For example, 3 coils may be spaced apart on disk 122 by a central angle of 120°, or four coils may be spaced apart on disk 122 by a central angle of 90°. Each of the U-shaped coils 131 is substantially symmetrical, such that its lower section, i.e., the section below the disc 122, is substantially the same as its upper section. The U-shaped coils 131, that FIG. 2 shows their general-principle shape, are in fact hollowed, and are designed to occupy many coil turns. FIG. 3 illustrates the manner in which the windings of a coil 131 are arranged within its hollowed sections. Initially, the positive end of the wire, starting at terminal 140, is provided to within the hollow of the coil. The winding first goes up, then along the upper hollow of section 132R, then along the connecting section 132c, then along the upper hollow of section 132L, then downwards to the lower portion of section 132L, then along the lower connecting section (not shown), ending at the lower portion of section 132R, and going upward again to repeat the same winding course. This winding procedure repeats plurality, in fact many times, to form many windings. Upon completion of the winding procedure, the winding ends at the negative port of terminal 140. It should be noted that such a structure of coil 131 is relatively simple to wind. The bobbin of each of the coils is typically made of plastic material, although it may be made of another non-inducting material such as ceramic, etc.

In one embodiment, a ferromagnetic (e.g., iron) core 125 is disposed between any two adjacent permanent magnets 123. More specifically, in the embodiment of FIG. 1, two ferromagnetic (e.g., iron) cores 125a and 125b, respectively, are disposed between the two permanent magnets 123. Therefore, the set of all the permanent magnets 123, together with the set of all the ferromagnetic cores 125 in between the adjacent permanent magnets, form a circular ring-type structure which passes through all the cavities 134 of the set of coils 131, respectively, allowing free rotation of the rotor disk 122, while the ring-type arrangement is continuously kept within said cavities of the coils 131. It has been found that the adding of the ferromagnetic cores in between each pair of permanent magnets is very important, as this structure contributes to a very significant reduction of the parasitic CEMF compared to the prior art.

FIGS. 1, 2, and 3 above show two U-shaped coils in the stator. It should be noted again, that the number of U-shaped coils, as well as the number of permanent magnets on the rotor may respectively vary. Preferably, the inputs (140 in FIG. 3) to the plurality of the coil coils are connected in parallel, such that all the positive ports are connected together, as well as all the negative ports. In order to assure continuous rotation of the rotor, the direction of the input current to the coils is periodically altered, in synchronization with the permanent magnet pole which is next to the respective coil. The synchronization is performed using one or more sensors, for example, Hall-type sensors 135 in FIG. 2, that are positioned in one or more of the coils sections 132.

As noted, it has been found that the parasitic magnetic losses in the motor of the invention, namely the CEMF, are extremely low compared to conventional prior art motors. While in conventional motors the level of the CEMF typically reaches 80%-90%, the level of the CEMF in the motor of the invention has been found to be between 10% to 12%.

### EXAMPLE

A motor according to the invention was implemented. The following parameters and results were respectively provided:

1. Number of U-shaped coils: 2;

2. Number of permanent magnets: 4;

3. Number of windings in each coil: 20;

4. Diameter of the wire that was used in the coils: 7 mm;

5. The level of the voltage supply: 8-20V DC;

6. The level of the current: 2×200 A=400 A;

7. The power of the motor: up to 50 KW;

8. The rate of change of the polarity of the current: 4 times per disk turn;

9. The number of rounds per minutes achieved: up to 3000 rpm;

10. The diameter of the disk: 400 mm.

11. The CEMF at a speed of 3000 rpm has been found to be no more than 12%.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1-12. (canceled)

13. An electric motor comprising:
A. A rotor which comprises:
a.A co-centric shaft and disk; and
b.A plurality of permanent magnets that are equi-angularly spaced and equi-radially disposed on said disk in a ring-like structure; and,
B. A stator which comprises:
c. A plurality of coils having a U-shaped structure in top view an double C-shaped structure in side view, said coils are equi-angularly spaced and equi-radially disposed with respect to said disk of the rotor, each section of said C-shaped structure has a cavity through which said ring-like structure and disk rotationally move; and
d.A plurality-of-wingdings coil within each of said U-shaped coils wherein the plurality of permanent magnets, together with ferromagnetic cores in between adjacent magnets, from the ring-like structure which passes through the cavity of the plurality of coils, allowing free rotation of the disk, while the ring-like structure is continuously maintained within said cavity of the coils.

14. An electric motor according to claim 13, wherein the U-shaped coils are attached to a stator base.

15. An electric motor according to claim 13, wherein the ferromagnetic cores are disposed between any two adjacent permanent magnets of the rotor, thereby to form a close ring.

16. An electric motor according to claim 13, wherein a DC current whose direction is alternated is supplied to said coils of the coils.

17. An electric motor according to claim 16, wherein all said coils are connected in parallel, such that they are all fed from a single DC source.

18. An electric motor according to claim 16, further comprising one or more sensors for sensing the position of the one or more of said permanent magnets relative to said coils, respectively, and for providing indication as to when to alter the direction f the DC current, respectively.

19. An electric motor according to claim 6, wherein each of said sensors is a Hall-type sensor.

20. An electric motor according to claim 17, wherein said alterations of the direction of the DC current is caused by a controller, and wherein said alterations are timed by a signal which is received from said one or more sensors.

21. An electric motor according to claim 13, wherein the poles of adjacent permanent magnets are arranged such that identical poles face one another, in an S-S, N-N . . . arrangement.

22. An electric motor according to claim 13, wherein the wingdings in each of the plurality of coils are formed by a single conductor which is repeatedly wound around a coil bobbin.

23. An electric motor according to claim 13 which is of relatively low current and relatively high voltage.

24. An electric motor according to claim 13, wherein the number of permanent magnets is twice the number of said U-Shaped coils.
